(19) United States
(12) Patent Application Publication
(10) Pub. No.: US 2021/0244063 A1
(43) Pub. Date: Aug. 12, 2021

(54) Pre-workout Effervescent Tablet

(71) Applicants: Shane Matthew Parker, Dana Point, CA (US); Stephen William Phalen, Capistrano Beach, CA (US); Ryan Michale Parker, Trussville, AL (US); Megan Michelle Parker, Dana Point, CA (US)

(72) Inventors: Shane Matthew Parker, Dana Point, CA (US); Stephen William Phalen, Capistrano Beach, CA (US); Ryan Michale Parker, Trussville, AL (US); Megan Michelle Parker, Dana Point, CA (US)

(21) Appl. No.: 16/783,992

(22) Filed: Feb. 6, 2020

(51) Int. Cl. A23L 33/175; A23L 2/40; A23L 33/105; A23P 10/28; A23P 20/10

(52) U.S. Cl. CPC A23L 33/175; A23L 2/40; A23P 20/10; A23P 10/28; A23L 33/105

(57) ABSTRACT

This invention relates to a pre-portioned single, multiple, or fractional serving(s) in effervescent tablet form, containing doses of stimulants, amino acids, vitamins, and minerals in unique quantities to enhance performance of exercise related activities. The composition and delivery of these components is unique and solves problems pertaining to the traditional packaging, composition, and delivery methods used for these products. This invention provides a product that can serve as a pre-workout stimulant, energy aid, or exercise related improvement supplement that is delivered in effervescent tablet form.

### FIELD OF INVENTION

This invention relates to a pre-portioned single, multiple, or fractional serving(s) in effervescent tablet form, containing doses of stimulants, amino acids, vitamins, and minerals in unique quantities to enhance performance of exercise related activities. The composition and delivery of these components are unique and solve problems pertaining to the traditional packaging, composition, and delivery methods used for these products. This invention provides a product that can serve as a pre-workout stimulant, energy aid, or exercise related improvement supplement that is delivered in effervescent tablet form.

### BACKGROUND OF THE INVENTION

Medical data shows that regular exercise leads to a healthier life. Despite the availability of gyms and health clubs, many people fail to get a sufficient quantity and quality of exercise. There are many obstacles in getting to the gym or participating in athletic activities. Energy levels and time are often a major contributing factor to effort dedicated to these activities. Athletes also try to push their abilities more and more. Though there are products that address energy levels and performance many of them do not adequately address convenience of on-the-go usage.

Nutritional supplements such as pre-workout, post-workout, performance enhancement, and energy boosts, as found in US 2009/0068300, US 2017/0150738, US 2013/0302382 and US 2018/0280430, are generally found in one of three forms: a powder, pill or capsule, or pre-made liquid. Each of these forms provides a specific problem to the user and renders the product difficult to consume. Powders are difficult and inconvenient to mix with water, they become clumpy, there is no uniform portion measurement device, and they emit a cloud of dust that is undesirable to breathe in. Pills/capsules are difficult and potentially painful to swallow. Often, they come in unusually large sizes, and could potentially be dangerous to the user. Pre-made liquid servings are generally sold as single serving, one-time use portions, and are expensive to purchase, difficult or bulky to store, and do not provide for consistent usage. They also limit potential beneficial ingredients that are rendered ineffective in liquid over a long period of time. For example, creatine monohydrate is not water stable, and loses potency over time.

To solve these problems, we have created an effervescent tablet that can be easily dissolved and administered in single, multiple, or fractional dosages. This tablet is comprised of a blend of stimulants and amino acids; and can also include vitamins and/or minerals. The composition of the tablet varies in order to achieve the specific objective desired (i.e. pre-workout, performance enhancement, energy boost, or post-workout) but the administration of the tablet is consistent. By combining the supplements in an effervescent form factor we are able to create a unique product that solves the problems present in the products available within the industry.

### SUMMARY OF THE INVENTION

The invention relates to a pre-workout effervescent tablot for addition to a portion of water which contains:

a. at least one stimulant,

b. at least one amino acid,

c. one or more compounds capable of providing effervescence when combined with a portion of water, and

d. optionally one or more other additives.

The tablet conveniently has a diameter of from one half to two inches.

In one aspect, the additives in the pre-workout effervescent tablet could include vitamins, minerals, dyes, colorant, flavoring, binder, sweetener, moisture inhibitor and lubricant or a mixture thereof.

In one aspect, the pre-workout effervescent tablet is lightly coated prevent exposure of the effervescent ingredients to atmospheric moisture.

In one aspect, the effervescent tablet contains at least one weak acid, and at least one alkali effervescent compounds, where the effervescent alkali is selected from the group consisting of sodium bicarbonate, potassium bicarbonate, calcium carbonate, and mixtures.

In one aspect, the stimulant comprises caffeine, teachrine, ginseng, or mixtures thereof, at from 0 mg to 500 mg.

In another aspect, the amino acid comprises beta alanine, creatine, L-citrulline, L-arginine, agmatine sulfate, L-isoleucine or mixtures thereof, and is present at from 1 g to 10 g.

The invention also relates to a method of preparing for an exercise workout, which includes the steps of

a. combining the pre-workout effervescent tablet of claim 1 with a portion of water,

b. allowing said effervescent tablet to dissolve, to form a solution or suspension,

c. consuming at least a portion of said solution or suspension prior to, during, or, immediately after said workout.

In one aspect, the solution or suspension is consumed at multiple times before, during and/or after the workout.

In one aspect, the tablet dissolution occurs in less than 5 minutes, preferably less than 4, more preferably less than 3, more preferably less than 2, and most preferably less than 1 minute.

In another aspect, at least a portion of said solution or suspension is consumed between five minutes and one hour prior to the start of the workout, more preferably from 10 minutes to 30 minutes prior to the start of the workout, and most preferably between 10 and 20 minutes prior to the start of the workout.

The invention also relates to a package having one or more of the pre-workout effervescent tablets where each tablet is protected from contact with atmospheric moisture.

### DESCRIPTION OF DRAWINGS

FIG. 1 shows the pre-workout tablet and container of quid before the pre-workout tablet is added to the liquid.

FIG. 2 shows the pre-workout tablet after it is put into the liquid in a container.

FIG. 3 shows the pre-workout tablet dissolving without agitation because of its effervescent nature,

FIG. 4 shows the liquid in the container aftere pre-workout tablet has completely dissolved.

FIG. 5 shows the isometric view of the pre-workout tablet.

FIG. 6 shows the top view of the pre-workout tablet.

FIG. 7 shows the bottom view of the pre-workout tablet.

FIG. 8 shows the side view of the pre-workout tablet.

FIG. 9 shows the front view of the pre-workout tablet.

### DETAILED DESCRIPTION OF THE INVENTION

The invention provides a pre-portioned, single, multiple, or fractional dosage, in effervescent tablet form, containing a combination of amino acids and stimulants. It can also include vitamins and minerals in order to achieve the blend necessary for the specific objective desired. The tablet provides an increase in energy, endurance and/or recovery during and after a workout.

### Tablet

The tablet of the invention can be of any form—such as, for example, round, square, cylindrical, disk-shape, etc. The key feature is that the dose is pre-proportioned, and preferably can easily be added through the opening of a container, such as a water bottle, cup, jar, etc., offering convenience of use. The tablet could be coated or uncoated. A lightly coated tablet has the advantage of preventing contact of the active ingredients with atmospheric moisture, and thus pre-maturely triggering the effervescent reaction. The tablet could be homogeneous or contain two or more separate portions having different compositions. The use of the term “tablet” is not meant to limit the invention to a solid, but it could be in the form of a capsule containing a gel or liquid. The tablet must dissolve quickly in water, totally dissolving in at least 7 minutes, preferably in at least 5 minutes, more preferably in at least 3 minutes, in at least 2 minutes, and most preferably within 1 minute of being added into the liquid. Conditions such as breaking the tablet into pieces, temperature of the liquid, shaking or agitation to the liquid and tablet, liquid type, such as water, carbonated water or beverages, juice, oil based liquids, dairy based liquids, liquids containing alcohol, etc., atmospheric altitudes, and the addition of other substances to the liquid such as citrus, alcohol, vinegar, dairy, solids, etc., may effect dissolve times. Furthermore, if the tablet is added to a liquid and then the container is sealed or unsealed, and agitated, depending on the type of liquid the tablet is dissolving into, it could cause an overflow of effervescent bubbles, liquid, or pressure build up in the sealed container.

The pre-portioned tablet may be used as a single tablet, or multiple tablets, for easy dosage based on the person, body type, and type of workout involved. Tablets containing different formulations can be provided, to meet the specific needs and objectives of each individual workout.

The tablet is meant to enhance the workout experience or person's energy level, and is not designed as a complete nutritional supplement, which would typically contain proteins and carbohydrates. The tablet could contain small amounts of proteins and carbohydrates, but in a preferred embodiment would not contain either, or would have carbohydrates and proteins at less than 20 percent, preferably less than 10 percent, and more preferably at less than 5 percent of the total concentration of the active ingredients in the tablet.

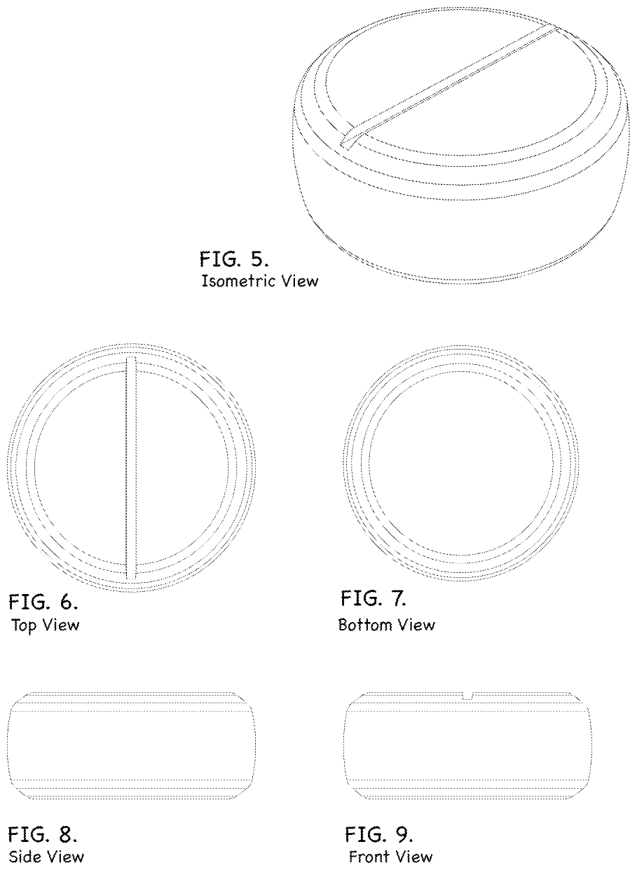

The tablets may come packaged singly, or in a multi-tablet form, such as in a tube-shaped container about 1-12 inches (25.4 mm-304.8 mm) in length. The tablet can range in size and have a diameter from one half inch (12.7 mm) to 2 inches (50.8 mm), and a thickness of 1-20 mm (0.0393701 inches-0.787402 inches), more preferred between 4-12 mm (0.15748 inches-0.472441 inches), and most preferred between 6-9 mm (0.23622 inches-0.354331 inches). The tablet can also range in weight 1 g-12 g, more preferably 3 g-9 g, and most preferably 5 g-7 g. The size of the tablet does not matter, and the tablet containing or not containing a perforation does not matter, as long as the tablet can fit into a container. These ranges are chosen because they have the best opportunity to successfully complete the dissolving process with ease, as a tablet too thin could dissolve faster, but could also break during processing, and a tablet too thick could prevent breakage for easy access to a container opening, such as a water bottle. Likewise, if a tablet is pre-portioned too compactly, it could slow the dissolving process, and a tablet pre-portioned too loosely or lightly could cause breakage in the tablet. Isometric, top, bottom side, and front views of the tablet are shown in FIGS. 5, 6, 7, 8, and 9.

### Effervescent

The tablet of the invention is effervescent, meaning that it dissolves quickly in liquid, such as water, creating bubbles that disperse the active ingredients quickly and evenly throughout the water container.

The effervescence may be caused by any means known in the art. For example, in one embodiment, a weak acid, such as, for example citric acid, tartaric acid, or amino acids, is combined with an effervescing alkali, such as for example sodium bicarbonate, potassium bicarbonate, and/or calcium carbonate. Asorbic acid or vitamin C can also be used as an acid combined with an effervescing alkali, such as for example sodium bicarbonate, potassium bicarbonate, and/or calcium carbonate.

The effervescent bubbling provides a convenient, non-agitation means for quickly and evenly distributing the active ingredients in the water container. Other benefits of the effervescence are that they provide electrolytes to the body, which are needed for working out, they provide a bubbly “high”, and are a visual, and sensual indication that the product is working. Electrolytes are often depleted in high intensity workouts so the addition of electrolytes before working out is beneficial.

### Stimulant

The effervescent tablet of the invention contains at least a stimulant and an amino acid. The stimulant causes a heightened state of alertness, motivation, and the determination to accomplish the workout. Typical stimulants for use in the effervescent tablet of the invention include, but are not limited to caffeine, ginseng, teachrine, and mixtures thereof. The levels of stimulant in the tablet depend on the size of the person, and the type and endurance of the workout. Typical levels of stimulant range from 10 mg to 450 mg, preferably 50 mg to 350 mg and more preferably 100 mg to 250 mg in each tablet. In another embodiment, typical levels of stimulant range from 1% to 10%, and preferably from 4% to 5% of the active ingredient base.

Multiple tablets could be used to provide larger dosages, for larger persons, long endurance workouts, or highly strenuous workouts. This stimulant is expected to raise the level of physiological activity or awareness within the central nervous system of the body. It can act to “trick” the body into not feeling fatigued, and thereby provide a longer workout.

### Amino Acid

Amino acids aid in energy generation, muscle recovery, and/or endurance, both during and after a workout. Typical amino acids useful in the tablet of the invention include, but are not limited to, beta alanine, creatine which may optionally be in impure or polymeric form, L-arginine, L-citrulline, L-isoleucine, agmatine sulfate and mixtures thereof. Typical levels of amino acids in each tablet range from 1 g to 10 g, preferably 2 g to 8 g and more preferably 3 g to 5 g in each tablet. In one embodiment, typical levels Amino acids can act to “trick” the body into not feeling fatigued, and thereby provide a longer workout.

### Vitamins and Minerals

Vitamins and minerals could optionally be present in the tablet at levels to enhance a specific workout, such as, but not limited to vitamin B complex, vitamin E, and vitamin C, biotin etc.

### Other Additives

Other additives may be added at typical levels for forming tablets. These include non-active carrier materials, such as calcium carbonate, dyes, colorants, natural and/or artificial favors, processing aids, anti-caking agents, binders, moisture inhibitors, sweeteners, and lubricants.

### Use

The tablet of the invention provides a pre-portioned, convenient and easy means of providing amino acids and stimulants prior to, during or after a workout.

By “workout” as used herein is meant a session of vigorous exercise or training, typically lasting from 15 to 240 minutes in duration, though it could be longer or shorter.

By “pre-workout” is meant prior to the start of a workout. Generally, this is a period from one hour to 2 minutes prior to the start of the workout, more generally 10 to 30 minutes, and in a preferred embodiment from 10-20 minutes prior to the start of the workout.

The tablet, or tablets of the invention are placed into water in a container, such as a water bottle, or the tablet may be added first, followed by the addition of water. Optionally, a portion of the water may be consumed before adding the tablet. Due to the effervescence, the tablet dissolves quickly, forming an evenly dispersed solution or suspension of the active ingredients in water. The number of tablets used, and dosage desired will vary depending on the age, weight, and physical condition of each person, as well as the duration and intensity of the workout.

The tablet is generally added to the water just prior to use—though it can be added at any time prior to being consumed. Because the effervescent tablet dissolves quickly, it is generally added from 1 minute to 30 minutes before being consumed.

The dissolved tablet forms a solution or suspension in the water. The exact amount of water, and the concentration of the solution is not important, as it is the amount of the active ingredients consumed that matters.

The solution or suspension can be consumed prior to, during, and even immediately after the workout, though the greatest benefit occurs when the tablet solution or suspension is consumed, or at least partially consumed about 15 to 20 minutes prior to the start of the workout. Consumption may occur earlier or later if desired. For a long duration workout, dosing may occur both prior to the start of the workout, and also at one or more times during the workout.

### Method of Use

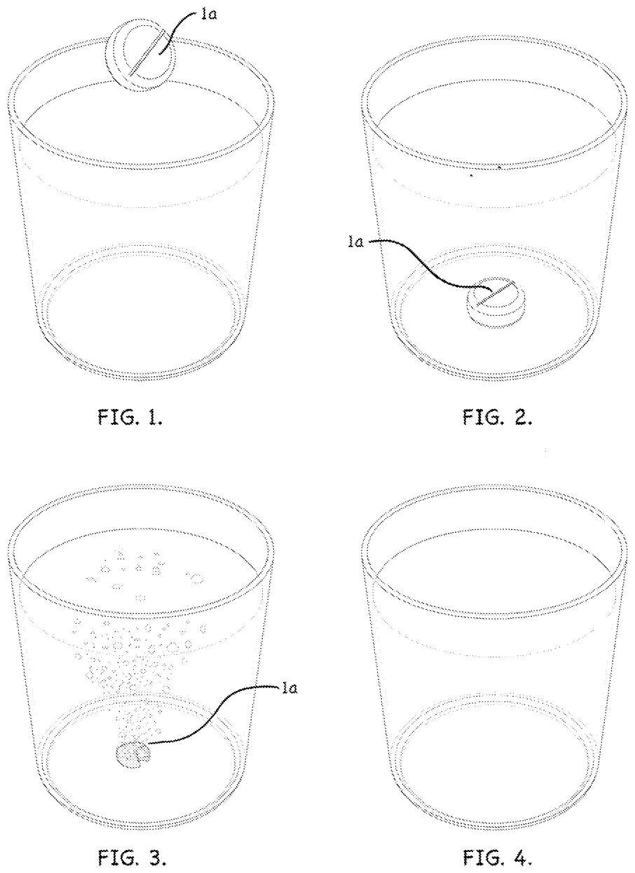

While not limiting the invention to any specific use, in one embodiment one would take one or more tablets of the invention, and a container of liquid (FIG. 1), and place the tablet into the container of liquid (FIG. 2). The pre-workout effervescent tablet easily dissolves in the liquid without agitation (FIG. 3) to form a solution of suspension (FIG. 4). The solution or suspension is consumed prior to, during, and/or immediately after a workout, to provide an increase in energy, endurance and/or recovery during and after a workout.

### Packaging

In one embodiment, the tablets of the invention are packaged in a manner to provide a quick, convenient, easy, and pre-measured means of storage and use of the tablet for pre-workout or energy boost use. Multiple tablets can be packaged together, in a convenient form. Preferably the tablets are individually wrapped to avoid contact with atmospheric moisture, which could pre-maturely trigger effervescence. The packages would fit easily in a purse, pocket, gym bag, locker, or anywhere near the point of use. A convenient package for a convenient pre-workout tablet. The packaging could come in a tube-shaped container about 1-12 inches in length (25.4 mm-304.8 mm), more preferably in a tube-shaped container about 3-10 inches in length (76.2 mm-254 mm), and most preferably in a tube-shaped container about 5-8 inches (127 mm-203.2 mm) in length.

### EXAMPLES

### Example 1

A tablet is formed containing 200 mg of caffeine, 1 g of beta alanine, 1 g of creatine monohydrate, 1 g of L-arginine and 1 g of L-citrulline as the active ingredients. 1.5 g of citric acid, 0.5 g of sodium bicarbonate and 0.5 g of potassium bicarbonate are used as the effervescing agent. Natural and artificial flavoring, as well as sweeteners—sucralose and acesulfame potassium are added for taste. Tablets are formed by mixing the ingredients together and inserting a pre-portioned amount into a pill press roughly ¾ inches (19.05 mm) in diameter. Once formed, the tablet is placed in 16 ounces of water in a water bottle. Total dissolution of the tablet was observed within 85 seconds of addition to the water bottle, without agitation.

### Example 2

A tablet is formed containing 1 g of sodium bi-carbonate, 1 g of citric acid, 1 g of dextrose, 200 mg of acesulfame potassium, 40 mg of aspartame, 400 mg of flavoring, 120 mg of caffeine, 750 mg agamatine sulfate, 750 mg beta alanine, 250 mg of L-isoleucine, 500 mg of citrulline malate, and 500 mg creatine HCL. Tablets are formed by mixing the ingredients together and inserting a pre-portioned amount into a pill press 25 mm in diameter and 4 mm in height. Once formed, the tablet is placed in 8 oz of water in a cup. Total dissolution of the tablet was observed within 2 minutes of addition to the water in the cup, without agitation. Put into a pill press 25 mm in diameter, and 5.25 mm in thickness.

What is claimed is:

1. A pre-workout effervescent tablet for addition to a portion of water comprising a pre-portioned effervescent tablet comprising:
a. at least one stimulant,
b. at least one amino acid,
c. one or more compounds capable of providing effervescence when combined with a portion of water, and
d. optionally one or more other additives.

2. The pre-workout effervescent tablet of claim 1, wherein said tablet has a diameter of from one half to two inches (12.7 mm-50.8 mm), and a thickness from 1-20 mm (0.0393701 inches-0.787402 inches) and a weight from 1 g to 12 g.

3. The pre-workout effervescent tablet of claim 1, wherein said additives include vitamins, minerals, dyes, colorant, natural and artificial flavoring, binder, moisture inhibitor and lubricant or a mixture thereof.

4. The pre-workout effervescent tablet of claim 1, wherein said tablet is lightly coated to prevent exposure of the effervescent ingredients to atmospheric moisture.

5. The pre-workout effervescent tablet of claim 1, wherein said effervescent compounds comprise at least one weak acid, and at least one effervescent alkali.

6. The pre-workout effervescent tablet of claim 5, wherein said effervescent alkali is selected from the group consisting of sodium bicarbonate, potassium bicarbonate, calcium carbonate, and mixtures thereof.

7. The pre-workout effervescent tablet of claim 1, wherein said stimulant comprises caffeine, teachrine, ginseng, or mixtures thereof.

8. The pre-workout effervescent tablet of claim 1, wherein said stimulant is present at from 10 mg to 450 mg.

9. The pre-workout effervescent tablet of claim 1, wherein said amino acid comprises beta alanine, creatine, L-citrulline, agmatine sulfate, L-isoleucine or mixtures thereof

10. The pre-workout effervescent tablet of claim 1, wherein said amino acid(s) are present at from 1 g to 10 g.

11. A method of preparing for an exercise workout, including the steps of
a. combining the pre-workout effervescent tablet of claim 1 with a portion of liquid,
b. allowing said effervescent tablet to dissolve, to form a solution or suspension, and
c. consuming at least a portion of said solution or suspension prior to, during, or, immediately after said workout.

12. The method of claim 11, wherein said solution or suspension is consumed at multiple times before, during and/or after the workout.

13. The method of claim 11, wherein said tablet dissolution occurs in less than 7 minutes, and preferably in less than 1 minute.

14. The method of claim 11, wherein at least a portion of said solution or suspension is consumed between 5 minutes and one hour prior to the start of the workout and preferably from 10 minutes to 20 minutes prior to the start of the workout,

15. A package containing one or more of the pre-workout effervescent tablets of claim 1, wherein each tablet is protected from contact with atmospheric moisture.
